(19) United States
(12) Patent Application Publication
(10) Pub. No.: US 2024/0367869 A1
(43) Pub. Date: Nov. 7, 2024

(54) MIXING CONTAINERS AND METHOD OF MAKING THEREOF

(71) Applicant: Atria Jamshidi, Irvine, CA (US)

(72) Inventor: Atria Jamshidi, Irvine, CA (US)

(21) Appl. No.: 18/144,102

(22) Filed: May 5, 2023

(51) Int. Cl. B65D 47/04; B01F 35/45; B01F 35/71

(52) U.S. Cl. CPC B65D 47/043; B01F 35/45; B01F 35/714; B65D 2547/06

(57) ABSTRACT

A storing device or container having a first end with an opening and a second end opposite to the first end, the opening being configured to be adjustable to control an amount of soluble material passing through the opening, and an attachment means for attaching the first end of the container to a vessel. The soluble material may be deposited into the storing device through at least one of the first end or second end. The storing device further includes one or more means for dispensing the soluble material into the vessel to mix with liquid within the vessel.

### FIELD OF THE DISCLOSURE

The embodiments described herein relate to containers, dispensers, and dry and wet material storage devices, and in particular, mixing containers and method of making thereof for storing together a liquid separately from a mixable material that when needed may be mixed together to provide a readily consumable mixture.

### BACKGROUND

Presently, many consumable health and fitness products are available to consumers that facilitate focused and/or comprehensive improvement in a person's health, exercise, recovery, and training regime enabling them to improve their lifestyle and reach one or more health or fitness goals. Some of these consumable products include health bars, protein shakes, energy drinks, smoothies, beverage, fruit drinks, vitamins, supplements, medications, minerals, herbs, and many other products. While many options exist for health or fitness improvements, consumers can be particular on the type of consumable products they use to improve their health or complement their fitness regime. Moreover, these habits and tendencies to use a particular product for a particular response or result may change over time. Generally, convenient or readily available products such as additives, supplements, powders, off the shelf drinks, or other products that can be quickly consumed, added to a drink, liquified, or taken from a bottle tend to be more popular. Consequently, individual preferences, needs, and responses often translates to numerous potential product choices throughout an individual's fitness or health regime. Moreover, consumers are finding healthier substitutes and options which sometimes requires making the fitness or health product from scratch using, for example, powders, minerals, herbs, fruits, vegetables, raw ingredients, and other constituents.

However, one problem individuals face when using current health and fitness products is the inconvenience in transporting or safeguarding their own ingredients (e.g., supplements, creatine, pre-workout, health, fitness and nutrition supplements, powders, etc.,) from becoming soiled, damaged, lost, or contaminated prior to use before, during, or after a workout. Another problem with current health and fitness products is the lack of a convenient device and method to mix and make a final consumable product from the user's choice of raw ingredients (e.g., herbs, minerals, supplements, powders, etc.,). Further, another difficulty with current consumable health or fitness products is finding the right mixing ratio of raw ingredient to drink or liquid (e.g., ingredients/powder to beverage ratio) to obtain a consumable product with minimal waste. Moreover, another problem with current consumable health or fitness products (e.g., supplements, creatine, pre-workout, health, fitness and nutrition supplements, powders, etc.,) is the lack of a convenient way to incorporate an individual's healthy ingredients into a consumable product. Individual preferences can make finding the right health or fitness consumable product difficult; with healthier raw ingredients being readily available to many consumers, it's now easier for users to make their own consumable health or fitness product (e.g., supplements, creatine, pre-workout, health, fitness and nutrition supplements, powders, etc.,) from various raw ingredients. Thus, allowing individuals to choose their raw ingredients and when to mix them to create a consumable product can facilitate a more convenient, affordable, and healthier consumable product for each individual.

### SUMMARY

The disclosed subject matter relates to a container having a first end and a second end opposite to the first end, the first end having an adjustable opening to control the flow of an amount of material passing through therefrom and an attachment means for attaching the first end to a vessel. The attachment means may be positioned on the first end and configured to secure the first end to the vessel.

The disclosed subject matter further relates to a method of making a container for dispensing a liquid mixture, the method includes forming a first opening in a first end of the container opposite to a second end of the container, attaching the first end to a vessel, and forming a movable surface, wherein the movable surface is configured to be adjacent to the first end, and wherein the movable surface adjusts the openness of the first opening to control an amount of material passing through therefrom.

The disclosed subject matter further relates to a method of using a container for dispensing a liquid mixture, the method includes attaching a first end of the container to a vessel, the first end having an adjustable first opening to control the flow of an amount of a soluble material passing through therefrom, moving a movable surface adjacent to the first end to adjust the openness of the first opening to control the flow of the soluble material passing through therefrom, and wherein movement of the movable surface to increase the openness of the first opening dispenses the soluble material positioned above the first opening into the vessel.

It is understood that other configurations of the present disclosure will become readily apparent to those skilled in the art from the following detailed description, wherein various configurations of the present disclosure are shown and described by way of illustration. As will be realized, the present disclosure of other different configurations and its several details are capable of modifications in various other respects, all without departing from the subject technology. Accordingly, the drawings and the detailed description are to be regarded as illustrative in nature and not restrictive.

### BRIEF DESCRIPTION OF THE DRAWINGS

Certain features of the present disclosure are set forth in the appended claims. However, for purpose of explanation, several implementations of the present disclosure are set forth in the following figures.

FIG. 1 illustrates a front schematic view of an example mixing container in accordance with one or more embodiments of the present disclosure.

FIG. 2A illustrates a left perspective view of an example vessel attachment for the mixing container of FIG. 1 in accordance with one or more embodiments of the present disclosure.

FIG. 2B illustrates a top right perspective view of an example vessel attachment for the mixing container of FIG. 1 in accordance with one or more embodiments of the present disclosure.

FIG. 3A illustrates a top left perspective view of the example cap for the mixing container of FIG. 1 in accordance with one or more embodiments of the present disclosure.

FIG. 3B illustrates a bottom right perspective view of another example cap for the mixing container of FIG. 1 in accordance with one or more embodiments of the present disclosure.

FIG. 4A illustrates a top perspective view of an example container in accordance with one or more embodiments of the present disclosure.

FIG. 4B illustrates a front view of an example container in accordance with one or more embodiments of the present disclosure.

FIG. 4C illustrates a bottom left perspective view of an example container in accordance with one or more embodiments of the present disclosure.

FIG. 5A illustrates a top left perspective view of an example container attachment for the container of FIG. 4A in accordance with one or more embodiments of the present disclosure.

FIG. 5B illustrates a bottom left perspective view of the example container attachment of FIG. 5A in accordance with one or more embodiments of the present disclosure.

FIG. 5C illustrates a top left perspective view of another example container attachment for the container of FIG. 4A in accordance with one or more embodiments of the present disclosure.

FIG. 6A illustrates a front perspective view of another example container and corresponding container attachment in accordance with one or more embodiments of the present disclosure.

FIG. 6B illustrates a front perspective view of another example container and corresponding container attachment in accordance with one or more embodiments of the present disclosure.

FIG. 6C illustrates a bottom perspective view of another example container and corresponding container attachment in accordance with one or more embodiments of the present disclosure.

FIG. 7A illustrates a top right perspective view of another example container in accordance with one or more embodiments of the present disclosure.

FIG. 7B illustrates a bottom right perspective view of the example container of FIG. 7A in accordance with one or more embodiments of the present disclosure.

FIG. 7C illustrates a bottom right perspective view of a cap for the container of FIG. 7A in accordance with one or more embodiments of the present disclosure.

FIG. 7D illustrates a front left perspective view of an example dispensing plate for the container of FIG. 7A in accordance with one or more embodiments of the present disclosure.

FIG. 7E illustrates a front left perspective view of another example dispensing plate for the container of FIG. 7A in accordance with one or more embodiments of the present disclosure.

FIG. 8 illustrates an example flow chart showing a method of making an example container for dispensing a liquid mixture in accordance with one or more embodiments of the present disclosure.

FIG. 9 illustrates an example flow chart showing a method of using an example container for dispensing a liquid mixture in accordance with one or more embodiments of the present disclosure.

Embodiments of the present disclosure and their advantages are best understood by referring to the detailed description that follows. It should be appreciated that like-reference-numerals are used to identify like-elements illustrated in one or more of the figures.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, methods, procedures, and components have not been described in detail so as not to obscure the related relevant feature being described. Also, the description is not to be considered as limiting the scope of the embodiments described herein. The drawings are not necessarily to scale, and the proportions of certain parts have been exaggerated to better illustrate details and features of the present disclosure.

Various features of the present disclosure will now be described and is not intended to be limited to the embodiments shown herein. Modifications to these features and embodiments will be readily apparent to those skilled in the art, and the principles defined herein may be applied to other embodiments without departing from the scope of the disclosure.

In the following detailed description, numerous specific details are set forth by way of examples in order to provide a thorough understanding of the relevant teachings. However, it should be apparent that the present teachings may be practiced without such details. In other instances, well known methods, procedures, components, and/or processes have been described at a relatively high-level, without detail, in order to avoid unnecessarily obscuring aspects of the present teachings.

For individuals who prefer to select their own ingredients or tailor their health or fitness product for their individual health, exercise, recovery, and training regime find it inconvenient to transport or safeguard their health and fitness products (e.g., ingredients, powders, shakes, etc.,) from becoming soiled, damaged, lost, or contaminated prior to use. Moreover, individual's lack a convenient device and method to mix and make a final consumable product from their choice ingredients (e.g., herbs, minerals, supplements, powders). Further, another difficulty individuals face is the lack of readily knowing the right proportion of raw ingredient to liquid ratio to quickly obtain a consumable product with minimal waste. Moreover, another problem with current consumable health or fitness products (e.g., supplements, creatine, pre-workout, health, fitness and nutrition supplements, powders, etc.,) is the lack of a convenient way to incorporate an individual's healthy ingredients into a consumable product.

Various embodiments of the present disclosure provide a solution to one or more of the above technical problems and others. In one embodiment, a mixing container having a plurality of chambers to process, dispense, or mix ingredients is provided to allow raw ingredients to be added and mixed with a drink or liquid for immediate consumption. In certain embodiments, a mixing container with one chamber to process, dispense, or mix ingredients is provided to allow a convenient and easily transportable device and method for quickly making a health or fitness consumable product. In many embodiments, a container attachment is provided with the mixing container to securely store and transport raw ingredients for later mixture with a liquid or drink. In certain embodiments, a cap, and a vessel attachment are provided with the mixing container to allow the raw ingredients to be added to the mixing container and sealed within the container using the cap, dispensed using the container attachment into the vessel attachment for mixing. In some embodiments, a mixing device is provided with the mixing container to mix or process the ingredients in at least one of the mixing container or the vessel attachment using the mixing device. These and other embodiments are described in the present disclosure for providing a solution to one or more of the above technical problems and others, thereby allowing individuals to choose their raw ingredients and when to mix them to create a consumable product that is more convenient, affordable, and healthier.

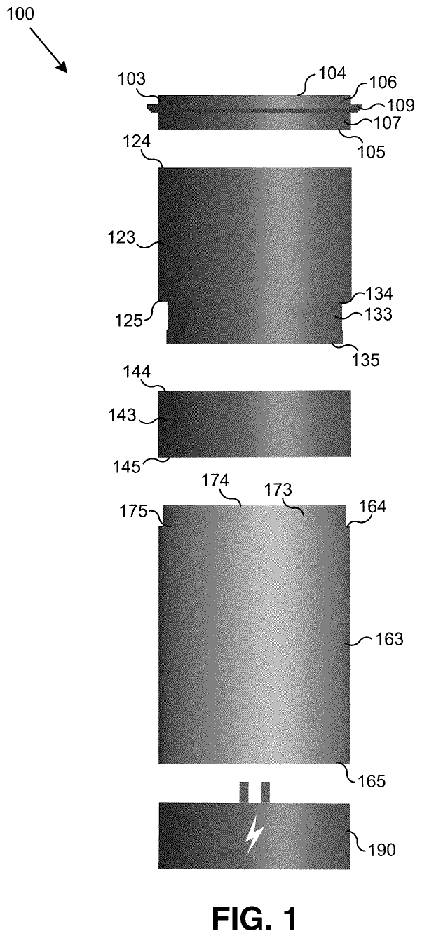

FIG. 1 illustrates a front schematic view of an example mixing container in accordance with one or more embodiments of the present disclosure. As shown in FIG. 1, the mixing container 100 may include at least one of: a cap 103, a container 123, a container attachment 143, and a vessel 163. The example cap 103 may be configured to include a first end 104 and a second end 105 opposite the first end 104, a lid 109 may be formed between an upper surface 106 and a lower surface 107 of the cap 103. In some embodiments, the first end 104 of the cap 103 may be configured to be at least partially or completely covered or sealed and the second end 105 may be configured to have an opening and a cavity formed between the first end 104 and the second end 105 of the cap 103. The example container 123 may be configured to include an upper end 124 and a lower end 125 opposite the upper end 124.

In many embodiments, the container 123 may include a protruding surface 133 having an upper boundary 134 attached to the container 123 and a lower boundary 135 opposite to the upper boundary 134. In some embodiments, the upper boundary 134 of the protruding surface 133 may be configured to be at least partially or completely opened and the lower boundary 135 may be configured to have an opening or a cavity formed between the upper boundary 134 and the lower boundary 135 of the protruding surface 133. In some embodiments, the container 123 may be configured to have only an upper end 124 and a lower end 125 without a protruding surface. In some embodiments, at least one of the upper end 124 and the lower end 125 of the container 123 may be configured to be at least partially or completely open with a cavity being formed between the upper end 124 and the lower end 125 of the container 123. The container 123 may store at least one of: a soluble material, a partially or wholly insoluble material, herbs, minerals, supplements, powders, frozen materials (e.g., ice), or other raw ingredients that are either ready to mix or require further processing (blending, mixing, grinding, etc.,) (hereinafter referred to as “material” or “soluble material”).

The example container attachment 143 may be configured to include a top end 144 and a lower end 145 opposite the top end 144. In some embodiments, at least one of the top end 144 and the lower end of the container attachment 143 may be configured to be at least partially or completely open with a cavity being formed between the top end 144 and the lower end of the container attachment 143.

The example vessel attachment 163 may be configured to include a top boundary 164 and a bottom boundary 165 opposite to the top boundary 164. In many embodiments, the vessel attachment 163 may include a protruding piece 173 having a lower boundary 175 attached to the vessel attachment 163 and an upper boundary 174 opposite to the lower boundary 175. In some embodiments, the vessel attachment 163 may be configured to have only a top boundary 164 and a bottom boundary 165 without a protruding surface. In some embodiments, at least one of the bottom boundary 165 and the top boundary 164 of the vessel attachment 163 may be configured to be at least partially or completely open with a cavity being formed between the bottom boundary 165 and the top boundary 164 of the vessel attachment 163. The vessel attachment 163 may store or provide at least one of: a soluble material, a partially or wholly insoluble material, a liquid, a beverage, herbs, minerals, supplements, powders, frozen materials (e.g., ice), or other raw ingredients that are either ready to mix or require further processing (blending, mixing, grinding, etc.,) (hereinafter referred to as a “mixing material” or “liquid” or “drink”).

The mixing container 100 may further include a power source 190 (e.g., a battery device, power adapter, etc.,) configured to provide power for a mixing device assembly (e.g., shaft, rod, gear, blade, motor, bearings, gaskets, agitator, circuit board, etc.,) positioned wholly or partially within the vessel attachment 163. The mixing device assembly may include, for example, a mixing device 267 configured to have one or more blades 267a to blend the material dispensed into vessel attachment 163 from the container 123. In some embodiments, the power source 190 may include part of the mixing device assembly, for example, the shaft, rod, gear, bearings, gaskets, agitator, motor, circuit board, etc., needed to operate the mixing device 267 and rotate one or more blades 267a. In certain embodiment, the vessel attachment 163 may further include bearings, gaskets, and agitator with the one or more blades 267a.

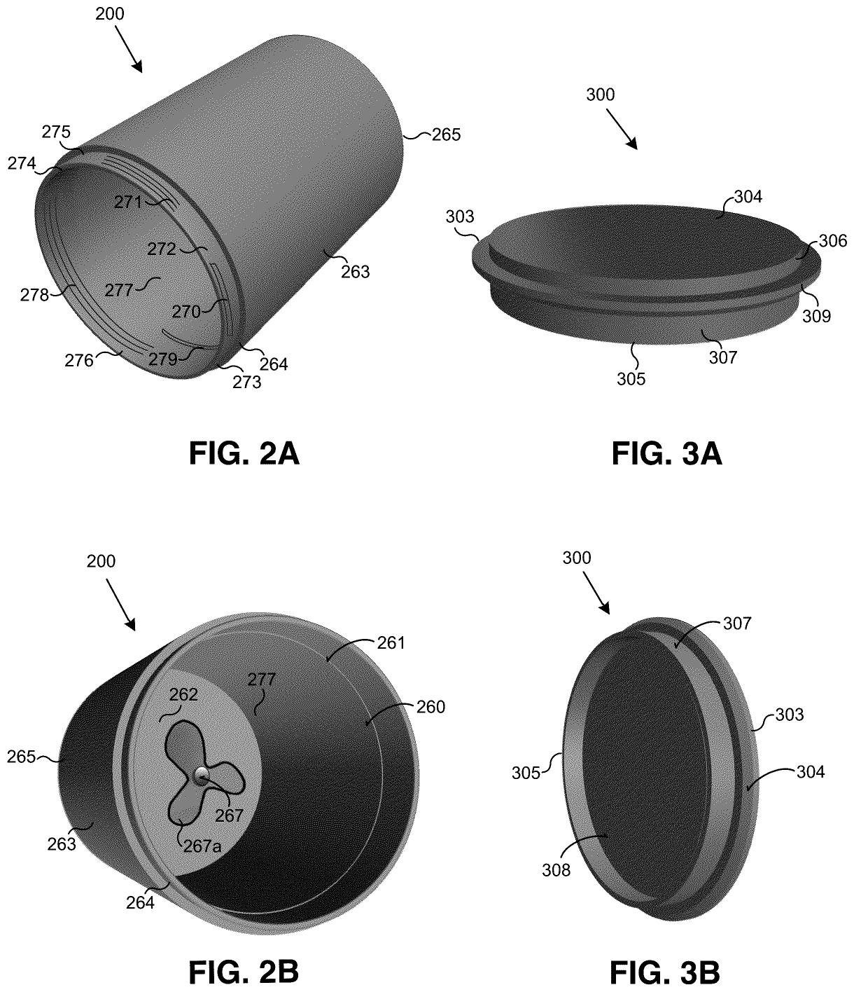

FIG. 2A illustrates a left perspective view of an example vessel attachment for the mixing container of FIG. 1 in accordance with one or more embodiments of the present disclosure. As shown in FIG. 2A, the example vessel attachment 200 may include a vessel body 263 having a top boundary 264 and a bottom boundary 265 opposite to the top boundary 264. The vessel body 263 may include one or more cavities 277 formed between at least the bottom boundary 265 and the top boundary 264. The protruding piece 273 may be configured to have a lower boundary 275 attached to the vessel body 263 at, for example, the top boundary 264. Further, the protruding piece 273 may include an upper boundary 174 opposite the lower boundary 175. The inside surface 276 of the protruding piece 273 may include at least one of: one or more grooves 278 or surface features 279 for attaching and securing the container 123 or the container attachment 143 to the vessel body 263. The surface features 279 may include at least one of: threads, one or more grooves, hooks, notches, pressable/slidable button/notch, recesses, bumps, pillars, protrusions, cavities, pins, latches, or the like to receive and secure the container 123 or the container attachment 143 to the vessel body 263. In some embodiments, the inside surface 276 of the protruding piece 273 may include a plurality of surface features 279.

In certain embodiments, the outside surface 272 of the protruding piece 273 may include at least one of: one or more grooves 271 or surface features 270 for attaching and securing the container 123 or the container attachment 143 to the vessel body 263. The surface features 270 may include at least one of: threads, one or more grooves, hooks, notches, pressable/slidable button/notch, recesses, bumps, pillars, protrusions, cavities, pins, latches, or the like to receive and secure the container 123 or the container attachment 143 to the vessel body 263. In some embodiments, the outside surface 272 of the protruding piece 273 may include a plurality of surface features 270. The vessel attachment 200 and vessel body 263 may be made of various materials, not limited to, for example, metals, alloys, plastics, wood, polycarbonate materials, polypropylene, polyethylene terephthalate (PET), polyethylene terephthalate glycol (PETG), acrylonitrile butadiene styrene (ABS), nylon, resins, graphite, and carbon fiber and the like. The vessel attachment 200 may be configured to store raw ingredients, liquids, insoluble or soluble materials, and the like.

FIG. 2B illustrates a top right perspective view of an example vessel attachment for the mixing container of FIG. 1 in accordance with one or more embodiments of the present disclosure. As shown in FIG. 2B, the example vessel attachment 200 may include a vessel body 263 having a top boundary 264 and a bottom boundary 265 opposite to the top boundary 264. The vessel body 263 may include one or more cavities 277 formed between a bottom surface 262 and the top boundary 264. In some embodiments, the inside surface 260 of the vessel body 263 may include at least one of: one or more surface features 261 for attaching and securing the container 123 or the container attachment 143 to the vessel body 263. The surface features 261 may include at least one of: threads, one or more grooves, hooks, notches, pressable/slidable button/notch, recesses, bumps, pillars, protrusions, cavities, pins, latches, or the like to receive and secure the container 123 or the container attachment 143 to the vessel body 263. In some embodiments, the inside surface 260 of the vessel body 263 may include a plurality of surface features 261.

In some embodiments, the vessel attachment 200 may include one or more mixing devices 267 configured to process, liquefy, chop, puree, mix, shredded, crush, ground, or blend the material in the vessel attachment 200 or vessel body 263. The mixing device 267 may include, for example, one or more blades 267a configured to blend the material in vessel body 263 with the material in the container 123. In some embodiments, at least one of the container 123 or vessel attachment 200 may be electrically connected or coupled to a battery or power source to power and operate the mixing device 267. Although the vessel attachment 200 is shown as a cylinder, any shape can be used to store raw ingredients, liquids, insoluble or soluble materials, and the like, for example, a spherical, elliptical, rectangular or square shaped vessel attachment may be used. Moreover, the dimensions of the vessel attachment 200 may be adjusted as desired to provide convenient or ease of transport, for example, the dry volume measure of the container may be between 4-500 cm³, the fluid volume of the container may be between 4-25 fluid ounces, and the length, height, and width of the container may be between 3 cm to 30 cm. In many embodiments, the cavity 277 may be configured to facilitate either precise or adequate space for a desired quantity of liquid, drink or beverage to be mixed within the vessel body 263 with the material stored in the container 123.

FIG. 3A illustrates a top left perspective view of the example cap for the mixing container of FIG. 1 in accordance with one or more embodiments of the present disclosure. As shown in FIG. 3A, the example cap 300 may include a cap body 303 having a first end 304 and a second end 305 opposite to the first end 304, the second end 305 being configured to slide into a cavity of the container 123 formed into at least the upper end 124 of the container 123. In some embodiments, the cap body 303 may include an upper surface 306 and a lower surface 307. In certain embodiments, the cap 303 may further include a lid 309 that may be configured to cover the cavity of the container 123.

FIG. 3B illustrates a bottom right perspective view of another example cap for the mixing container of FIG. 1 in accordance with one or more embodiments of the present disclosure. As shown in FIG. 3B, the example cap 300 may include a cap body 303 having a first end 304 with an interior surface 308 and a second end 305 opposite to the first end 304, the second end 305 being configured to slide into a cavity of the container 123 formed into at least the upper end 124 of the container 123. In some embodiments, the cap body 303 may include a lower surface 307. In some embodiments, the first end 304 may be configured to cover the cavity of the container 123. In certain embodiments, the lower surface 307 may sleeve into the upper end 124 of the container 123 with the interior surface 308 covering the cavity of the container 123.

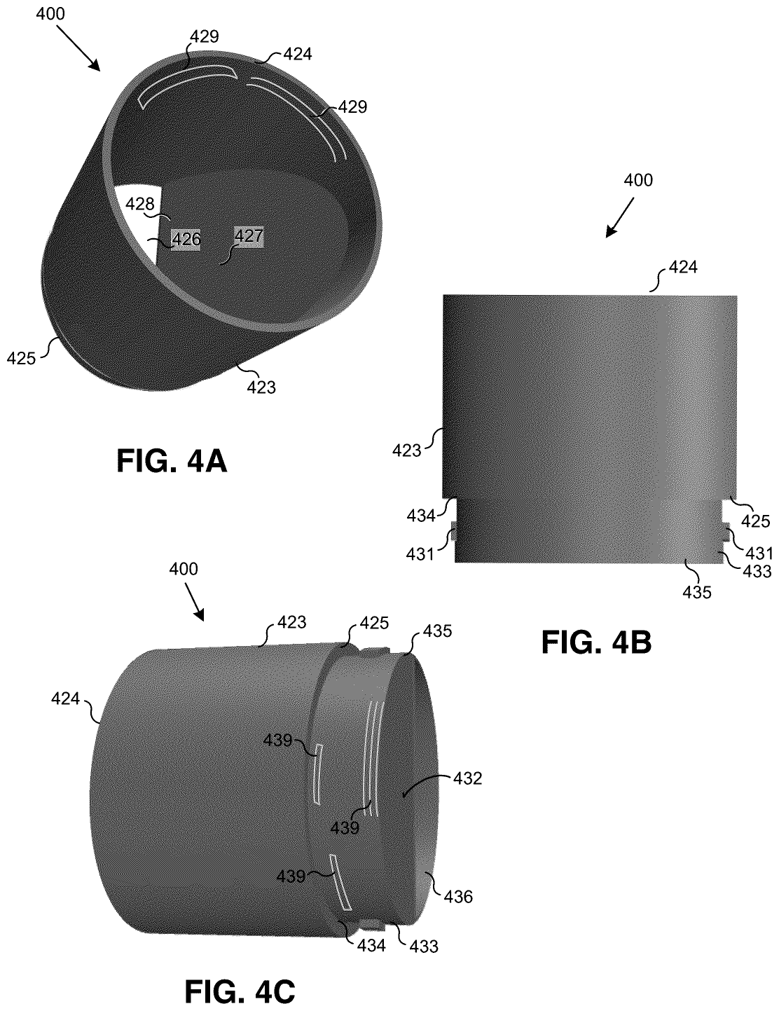

FIG. 4A illustrates a top perspective view of an example container in accordance with one or more embodiments of the present disclosure. As shown in FIG. 4A, the example container 400 may include a container body 423 having an upper end 424 and a lower end 425. The container body 423 may include at least one interior surface 428 to, for example, facilitate dispensing material (e.g., soluble material) within the container body 423 or inside cavity 427 out of the lower end 425 (e.g., into a vessel body 263). In some embodiments, at least one of the upper end 424 and the lower end 425 of the container body 423 may be configured to be at least partially or completely open with the cavity 427 being formed between the upper end 424 and the lower end 425 of the container 423. In certain embodiments, the interior surface 428 may comprise of a plurality of surfaces. In some embodiments, the interior surface 428 may be configured to have at least one of a funnel shape, a conic shape, a plurality of flat and/or curved surfaces as the interior surface 428. Moreover, one or more interior surfaces 428 may be configured to have a nonzero angle between the upper end 424 and a lower end 425 to facilitate and/or improve dispensing material into vessel body 263. In many embodiments, the cavity 427 may be configured to facilitate either precise or adequate space for a desired quantity of material to be mixed within the vessel body 263. In some embodiments, the container body 423 may be configured to include one or more surface features 429 that facilitate securing the upper end 424 to at least one of a mechanical device, an electrical device, a tool, or an appliance to receive a material or soluble material. In some embodiments, the soluble material may be dispensed out from opening 426 of the container body 423 into a vessel body 263 for further processing (e.g., mixing, diluting, etc.,).

Although the container 400 is shown as a cylinder, any shape can be used to store raw ingredients, liquids, insoluble or soluble materials, and the like, for example, a spherical, elliptical, rectangular or square shaped container may be used. Moreover, the dimensions of the container 400 may be adjusted as desired to provide convenient or ease of transport, for example, the dry volume measure of the container may be between 4-500 cm³, the fluid volume of the container may be between 4-25 fluid ounces, and the length, height, and width of the container may be between 3 cm to 30 cm. In many embodiments, the cavity 427 may be configured to facilitate either precise or adequate space for a desired quantity of dry or raw material (e.g., raw ingredients) to be dispensed into and/or mixed within the vessel body 263.

FIG. 4B illustrates a front view of an example container in accordance with one or more embodiments of the present disclosure. As shown in FIG. 4B, the example container 400 may be configured to include a protruding surface 433 fixed or coupled to a lower end 425 of the container body 423 opposite to the upper end 424. The protruding surface 433 may be configured to include an upper boundary 434 and a lower boundary 435. In many embodiments, the protruding surface 433 may include one or more grooves, threads, hooks, notches, pressable/slidable button/notch recesses, bumps, pillars, protrusions, cavities, pins, latches, or the like to receive and secure the container 423 to a container attachment 143. In some embodiments, the protruding surface 433 may include one or more grooves, threads, hooks, notches, pressable/slidable button/notch recesses, bumps, pillars, protrusions, cavities, pins, latches, or the like to receive and secure the container 423 to a vessel body 263. In some embodiments, the one or more interior surfaces 428 may be movable surfaces (e.g., turnable, rotatable, slidable, etc.,) to facilitate dispensing material (e.g., soluble material) out from container body 423. In certain embodiments, the container 400 may be configured to include one or more other movable surfaces positioned within the cavity 427 and/or within the upper end 424 and the lower end 425 of the container body 423. In certain embodiments, the protruding surface 433 may include one or more surfaces 432 positioned between the upper boundary 434 and a lower boundary 435. In some embodiments, the one or more surfaces 432 may be an exterior surfaces at an end of the protruding surface, for example, on, adjacent to, or formed over the lower boundary 435. In certain embodiments, the one or more surfaces 432 may be an interior surfaces at an end of the protruding surface, for example, on, adjacent to, or formed over the upper boundary 435. In many embodiments, the protruding surface 433 may provide an attachment means to secure, fix, mount, or couple the container body 423 to a vessel body 263 or to a container attachment 143. In many embodiments, the protruding surface 433 may include one or more surface features 431 that may include at least one of: threads, one or more grooves, hooks, notches, pressable/slidable button/notch recesses, bumps, pillars, protrusions, cavities, pins, latches, or the like to receive and secure the container 123 to a container attachment 143 and/or the vessel body 263.

FIG. 4C illustrates a bottom left perspective view of an example container in accordance with one or more embodiments of the present disclosure. As shown in FIG. 4C, the example container 400 may include a protruding surface 433 configured to have an opening 436 at the lower boundary 435 of the protruding surface 433 opposite to an upper boundary 434. Further, the protruding surface 433 may be fixed to a lower end 425 of a container body 423 opposite to an upper end 424 of the container body 423. The material (e.g., soluble material) being dispensed out of the container body 423 through the opening 426. In some embodiments, as shown in FIG. 4A, the soluble material may be dispensed out of an opening 426 of the container body 423. In many embodiments, the protruding surface 433 may include one or more surface features 439 that may include at least one of: threads, one or more grooves, hooks, notches, pressable/slidable button/notch, recesses, bumps, pillars, protrusions, cavities, pins, latches, or the like to receive and secure the container 123 to a container attachment 143 and/or the vessel body 263. The container 400 and container body 423 may be made of various materials, not limited to, for example, metals, alloys, plastics, wood, polycarbonate materials, polypropylene, polyethylene terephthalate (PET), polyethylene terephthalate glycol (PETG), acrylonitrile butadiene styrene (ABS), nylon, resins, graphite, and carbon fiber and the like. The container 400 may be configured to store dry or raw ingredients, liquids, partially insoluble or soluble materials, and the like.

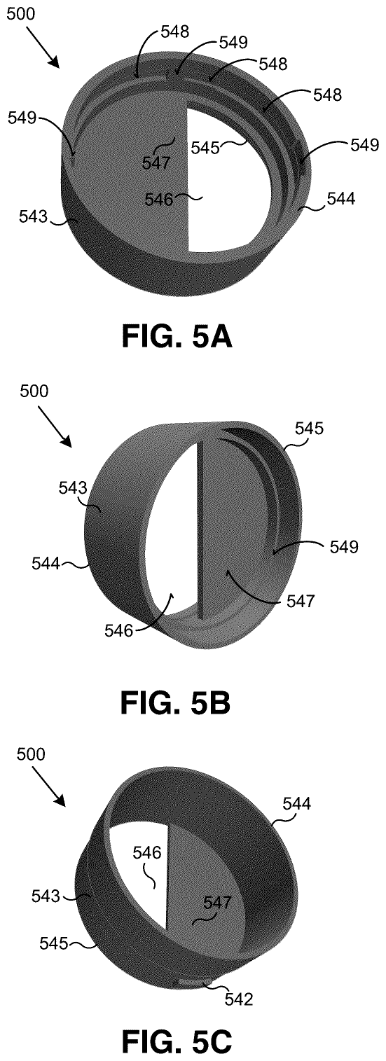

FIG. 5A illustrates a top left perspective view of an example container attachment for the container of FIG. 4A in accordance with one or more embodiments of the present disclosure. As shown in FIG. 5A, the example container attachment 500 may be configured to have a container attachment body 543 with a top end 544 and a lower end 545 opposite to the top end 544. The interior of the container attachment body 543 may include one or more surface features 548, 549 to receive, secure, fix to, or abut with one or more other surface features 431, 439 (e.g., of the container 423). The surface features 548, 549 may include at least one of: threads, one or more grooves, hooks, notches, pressable/slidable button/notch, recesses, bumps, pillars, protrusions, cavities, pins, latches, or the like to receive and secure to the container 123. For example, surface feature 549 of container attachment body 543 may receive surface feature 431 of protruding surface 433, the surface feature 431 may abut and move within surface feature 548 (e.g., one or more grooves or threads) and abut, lock, and secure between surface feature 549 and surface feature 548 (e.g., narrowing groove, protrusion, and pillar to lock surface feature 431 in place). In some embodiments, the container attachment body 543 may include one or more interior surfaces 547 and one or more openings 546 formed between the top end 544 and the lower end 545. Further, the shape of the one or more interior surfaces 547 of the container attachment 500 may correspond with, and fully or partially cover, at least one of: container opening 426 and protruding surface opening 432 to selectively allow the material within the container body 423 to dispense into a vessel body 263. In many embodiments, the container attachment 500 may provide a mechanical means to gradually increase the openness of the container opening 426 and/or protruding surface opening 436. Although the container attachment 500 is shown as a cylinder, any shape can be used, for example, a spherical, elliptical, rectangular or square shaped container attachment may be used.

FIG. 5B illustrates a bottom left perspective view of the example container attachment of FIG. 5A in accordance with one or more embodiments of the present disclosure. As shown in FIG. 5B, the example container attachment 500 may be configured to have a container attachment body 543 with a top end 544 and a lower end 545 opposite to the top end 544. In certain embodiments, the container attachment body 543 may include one or more interior surfaces 547 and one or more openings 546 formed between the top end 544 and the lower end 545. The interior of the container attachment body 543 may further include one or more surface features 549 to receive, secure, fix to, or abut with one or more grooves 271, 278 and/or one or more surface features 270, 279 of the vessel attachment 200, for attaching and securing the container attachment 500 to the vessel attachment 200.

FIG. 5C illustrates a top left perspective view of another example container attachment for the container of FIG. 4A in accordance with one or more embodiments of the present disclosure. As shown in FIG. 5C, the example container attachment 500 may be configured to have a container attachment body 543 with a top end 544 and a lower end 545 opposite to the top end 544. In certain embodiments, the container attachment body 543 may include one or more interior surfaces 547 and one or more openings 546 formed at, adjacent to, on, or over the top end 544 and/or the lower end 545. In some embodiments, the container attachment body 543 may be configured to include one or more exterior surface features 542 that may include at least one of: threads, one or more grooves, hooks, notches, pressable/slidable button/notch, recesses, bumps, pillars, cavities, pins, latches, or the like to receive and secure the container attachment 500 to the container 400. The container attachment 500 and container attachment body 543 may be made of various materials, not limited to, for example, metals, alloys, plastics, wood, polycarbonate materials, polypropylene, polyethylene terephthalate (PET), polyethylene terephthalate glycol (PETG), acrylonitrile butadiene styrene (ABS), nylon, resins, graphite, and carbon fiber and the like.

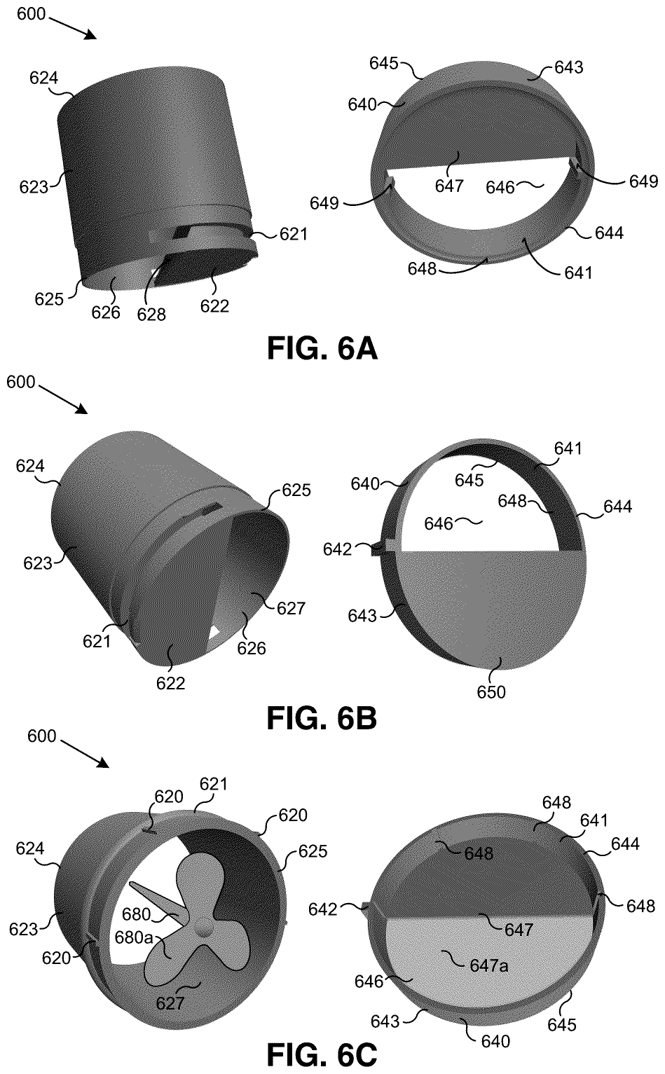

FIG. 6A illustrates a front perspective view of another example container and corresponding container attachment in accordance with one or more embodiments of the present disclosure. As shown in FIG. 6A, the example mixing container 600 may include a container body 623 and a container attachment body 643 configured to fit over container body 623, the mixing container 600 may be configured to store, dispense, or mix a soluble or mixing material. The container attachment body 643 may attach to the container body 623 between an upper end 624 and a lower end 625 of the container body 623. The container body 623 may be configured to have an interior surface 628 adjacent to an opening 626. In many embodiments, the interior surface 628 may be configured to have an incline to aid in dispensing material (e.g., soluble material) out from the container body 623. In certain embodiments, the container body 623 may include an exterior surface 622. In some embodiments, the exterior surface 622 may be adjacent to one or more surfaces of the interior surface 628. In certain embodiments, the exterior surface 622 shares a surface of the interior surface 628. In some embodiments, at least one of the exterior surface 622 and the interior surface 628 define the cavity 627 within the container body 623. The container attachment body 643 may include an exterior 640, an interior 641, at least one opening 646, and at least one interior surface 647 positioned between a top end 644 and a lower end 645 opposite to the top end 644.

The container body 623 may include one or more surface features 621 that may include at least one of: threads, one or more grooves, hooks, notches, pressable/slidable button/notch, recesses, bumps, pillars, protrusions, cavities, pins, latches, or the like to receive and secure the container attachment body 643 to the container body 623. Moreover, the container attachment body 643 may include one or more surface features 648, 649 that may include at least one of: threads, one or more grooves, hooks, notches, pressable/slidable button/notch, recesses, bumps, pillars, protrusions, cavities, pins, latches, or the like to sleeve over, slide into, couple, attach or fix to, or secure to a corresponding one or more surface features 621 of the container body 623. In some embodiments, one or more surface features 648, 649 may be configured to sleeve over, slide into, couple, attach or fix to, or secure to the exterior surface 622 and/or the interior surface 628 of the container body 623. For example, the surface features 649 of the container attachment body 643 may be configured to abut and movable couple to surface feature 621 of the container body 623. With the container attachment body 643 coupled to the container body 623, the interior surface 647 of container attachment body 643 may be rotated to partially or fully cover the opening 626 to control the openness of the opening 626. Further, the container attachment body 643 may be rotated to vertically align interior surface 647 with exterior surface 622 to fully open the opening 626. In some embodiments, the container attachment body 643 may include one or more surface features 648 (e.g., grooves) that facilitate movement (e.g., rotation) and/or seal a space between the exterior surface 622 and an interior 641 of the container attachment body 643.

FIG. 6B illustrates a front perspective view of another example container and corresponding container attachment in accordance with one or more embodiments of the present disclosure. As shown in FIG. 6B, the example mixing container 600 may include a container body 623 and a container attachment body 643 configured to fit into a cavity 627 of the container body 623, the mixing container 600 may be configured to store, dispense, or mix a soluble or mixing material. The container attachment body 643 may fit in the cavity 627 of the container body 623 between an upper end 624 and a lower end 625 of the container body 623. The container body 623 may be configured to have an exterior surface 622 and at least one opening 626. The container attachment body 643 may include an exterior 640, an interior 641, at least one opening 646, a top end 644 and a lower end 645 opposite to the top end 644, and at least one exterior surface 650 positioned on, adjacent to, covering, or formed over a top end 644.

In some embodiments, the container attachment body 643 may include one or more exterior surface features 642 that may include at least one of: threads, one or more grooves, hooks, notches, pressable/slidable button/notch, recesses, bumps, pillars, protrusions, cavities, pins, latches, or the like to sleeve over, slide into, couple, attach or fix to, or secure to a corresponding one or more surface features 621 of the container body 623. In some embodiments, one or more surface features 648, 649 may be configured to sleeve over, slide into, couple, attach or fix to, or secure to the exterior surface 622 and/or the interior surface 628 of the container body 623. For example, the surface features 649 of the container attachment body 643 may be configured to abut and movable couple to surface feature 621 of the container body 623. With the container attachment body 643 coupled to the container body 623, the interior surface 647 of container attachment body 643 may be rotated to partially or fully cover the opening 626 to control the openness of the opening 626. Further, the container attachment body 643 may be rotated to vertically align interior surface 647 with exterior surface 622 to fully open the opening 626. The exterior surface 650 of container attachment body 643 may rotate over and seal the opening 626 to prevent material (e.g., soluble material) from fall out from container body 623 or enter a vessel attachment 200 that may be coupled to the container body 623 or the container attachment body 643. In some embodiments, the container attachment body 643 may include one or more surface features 648 (e.g., grooves) that facilitate movement (e.g., rotation) and/or seal a space between the exterior surface 622 and an interior 641 of the container attachment body 643. In certain embodiments, the container body 623 may include one or more surface features 642 (e.g., threads, bumps, grooves) that facilitate movement (e.g., rotation) and/or seal a space between the exterior surface 622 of the container body 623 and an interior 641 of the container attachment body 643.

FIG. 6C illustrates a bottom perspective view of another example container and corresponding container attachment in accordance with one or more embodiments of the present disclosure. As shown in FIG. 6C, the example mixing container 600 may include a container body 623 and a container attachment body 643 configured to sleeve over the container body 623 to cover a cavity 627 of the container body 623, the mixing container 600 may be configured to store, dispense, or mix a soluble or mixing material. The surface features 648 may slide into surface features 620 of the container body 623 and lock into, abut, or secure to surface features 621 of the container body 623. In some embodiments, at least one of the surface features 620, 621 may rotate or include one or more grooves (e.g., surface feature 621) for rotating the container attachment body 643 to adjust an openness of the cavity 627. The container attachment body 643 may include a one or more interior surfaces 647, 647a. The one or more interior surface 647a may be spring loaded or retractable between and open and closed position to allow an openness of the opening 646 to be adjusted (e.g., mechanically) by moving or turning the container attachment body 643.

The surface features 620, 621 may hold one or more interior surfaces 647, 647a in an open position during the twisting or rotating motion. For example, the interior surface 647 may retract to an open position while being held open by surface feature 620. Moreover, in certain embodiments interior surfaces 647, 647a may be a twistable surface, for example, a silicone or rubbery surface that may be twisted to increase an openness of the opening 646 to enable material to flow out from the container 623. In certain embodiments, the container body 623 may include one or more mixing devices 680 configured to process, liquefy, chop, puree, mix, shredded, crush, ground, or blend the material in the container body 623. The mixing device 680 may include, for example, one or more blades 680a configured to blend the material in vessel body 263 with the material in the container 623. In some embodiments, at least one of the container 623 or vessel attachment 200 may be electrically connected or coupled to a battery or power source to power and operate the mixing device 680.

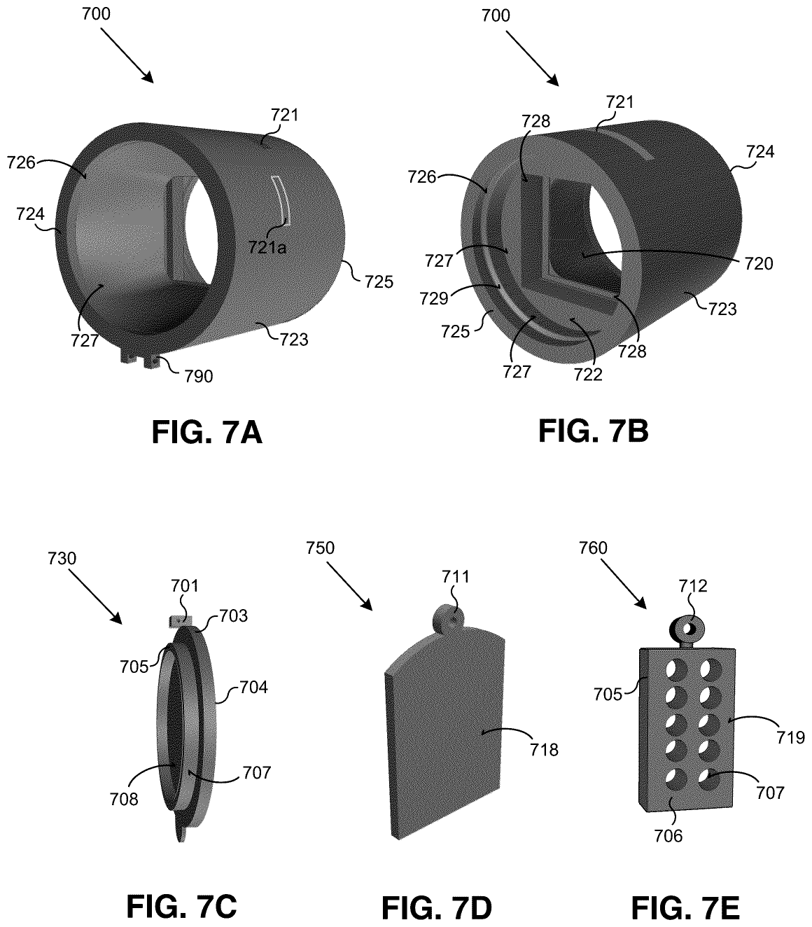

FIGS. 7A-7B illustrate a top and bottom right perspective view of another example container in accordance with one or more embodiments of the present disclosure. As shown in FIGS. 7A-7B, the example container 700 may include a container body 723 having an upper end 724 and a lower end 725. The container body 723 may include at least one interior surface 728 to, for example, facilitate dispensing material (e.g., soluble material) within the container body 723 or inside one or more cavities 727 out of the lower end 725 (e.g., into a vessel body 263). In some embodiments, at least one of the upper end 724 and the lower end 725 of the container body 723 may be configured to be at least partially or completely open with the cavity 727 being formed between the upper end 724 and the lower end 725 of the container 723. The container body 723 may include one or more openings 726 configured to receive a cap 730 that may couple to a connection 790 of the container body 723. The container body 723 may include one or more surface features 721, 721a (e.g., a groove and a pressable/slidable button/notch) that receives a dispensing plate 750. The soluble material may be deposited into the container body 723 by displacing the cap 730 and dispensed from the container body 723 by moving the dispensing plate 750 to adjust an openness of the opening 720. The container body 723 may be configured to include multiple interior surfaces 722, 728 and surface features 728, 729 to facilitate attaching the container body 723 to a vessel attachment 200. The interior surfaces 722, 728 and surface features 728, 729 may be adjusted as need to accommodate a corresponding dispensing plate 750.

FIG. 7C illustrates a bottom right perspective view of a cap for the container of FIG. 7A in accordance with one or more embodiments of the present disclosure. As shown in FIG. 7C, the example cap 750 may include a cap body 703 having a first end 704 and a second end 705 opposite to the first end 704, the second end 705 being configured to slide into a cavity 727 of the container 723 formed into at least the upper end 724 of the container 723. In some embodiments, the cap body 703 may include a lower surface 307. In certain embodiments, the cap 703 may further include a connector 701 to movably couple to a connection 790 of the container 723.

FIG. 7D illustrates a front left perspective view of an example dispensing plate for the container of FIG. 7A in accordance with one or more embodiments of the present disclosure. As shown in FIG. 7D, the example dispensing plate 750 includes a dispensing body 718, the dispensing body 718 may include a tab 711 to facilitate movement of the dispensing body 718 within the surface feature 721 to adjust the openness of the opening 720. Although the shape of the dispensing body 718 is shown as a rectangle, any shape may be used, for example, a circular, elliptical, or square shaped dispensing body may be used to fit into a surface feature 721. The dispensing body 718 may be configured to secure and adjust the openness of the opening 720 to facilitate storing of raw ingredients, insoluble or soluble materials, and the like in the container body 723. In some embodiments, the dispensing plate 750 may be spring loaded to enable a retractable means to increase the openness of opening 720.

FIG. 7E illustrates a front left perspective view of another example dispensing plate for the container of FIG. 7A in accordance with one or more embodiments of the present disclosure. As shown in FIG. 7E, the example dispensing plate 760 includes a dispensing body 719, the dispensing body 719 may include a tab 712 to facilitate movement of the dispensing body 719 within the surface feature 721 to adjust the openness of the opening 720. Although the shape of the dispensing body 719 is shown as a rectangle, any shape may be used, for example, a circular, elliptical, or square shaped dispensing body may be used to fit into a surface feature 721. The dispensing plate 760 may include multiple surfaces, for example, a non-porous surface 705 and a porous surface 706 having one or more openings 707. The dispensing body 719 may have a non-porous setting to prevent flow of material out of container 723 when the non-porous surface 705 is facing towards upper end 724, and to allow flow of material out of container 723 when the porous surface 706 is facing towards upper end 724. Thus, the dispensing body 719 may allow material to flow out from container 723 upon rotation of the dispensing body 719 from a non-porous surface 705 to a porous surface 706 within surface feature 721. In some embodiments, the dispensing body 719 may be gradually adjusted to adjust an openness of opening 720 corresponding to the degree of rotation away from the non-porous surface 705 and towards the porous surface 706. Thus, the dispensing body 719 may be configured to secure and adjust the openness of the opening 720 to facilitate storing of raw ingredients, insoluble or soluble materials, and the like in the container body 723. Moreover, in some embodiments the dispensing body 719 may be configured to be spring loaded within surface feature 721 to, for example, retract to a non-porous surface 705 to prevent material from flowing out of container 723.

In certain embodiments, one or more of the surface features 261, 270-271, 278-279, 429, 431, 439, 542, 548-549, 621, 642, 648-649, 721-721a, 728-729, may be pressable, slidable, rotatable, retractable, spring loaded, movable, or otherwise actionable to facilitate locking, securing, or removing/detaching the container 123, the vessel attachment 163, the cap 103, or the dispensing plate 750, 760 to or from the mixing container 100. Moreover, the shape and dimensions of the surface features may be adjusted to fit the shape and dimensions of the mixing container 100, or any components thereof, for example, the container 123, the vessel attachment 163, the cap 103, or the dispensing plate 750, 760.

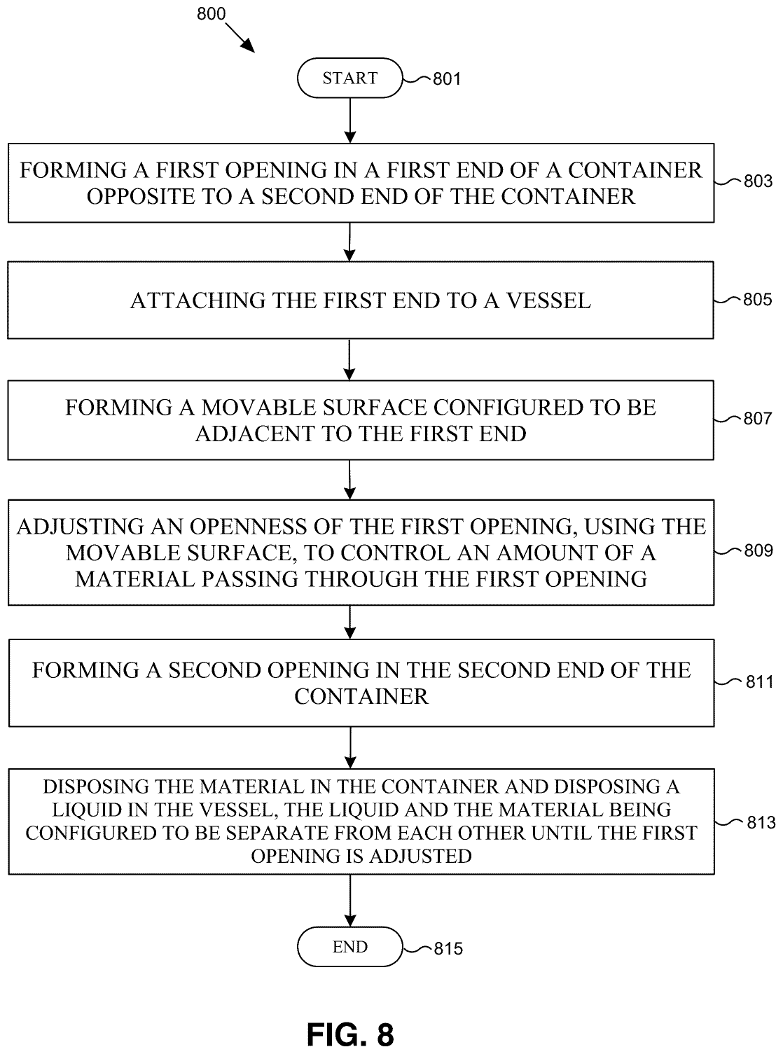

FIG. 8 illustrates an example flow chart showing a method of making an example container for dispensing a liquid mixture in accordance with one or more embodiments of the present disclosure. These exemplary methods are provided by way of example, as there are a variety of ways to carry out these methods. Each block shown in FIG. 8 represents one or more processes, methods or subroutines, carried out in the exemplary method. FIGS. 1-7F show example embodiments of carrying out the method of FIG. 8 for, for example, making a mixing container that facilitates a more convenient, affordable, and healthier consumable product for individuals who choose their raw ingredients and when to mix them to create the consumable product. Each block shown in FIG. 8 represents one or more processes, methods or subroutines, carried out in the exemplary method. The exemplary method may begin at block 801. Method 800 may be used independently or in combination with other methods or process for making a mixing container that facilitates a more convenient, affordable, and healthier consumable product for individuals who choose their raw ingredients and when to mix them to create the consumable product. For explanatory purposes, the example process 800 is described herein with reference to the digging tools and blades of FIGS. 1-7F. Further for explanatory purposes, the blocks of the example process 800 are described herein as occurring in serial, or linearly. However, multiple blocks of the example process 800 may occur in parallel. In addition, the blocks of the example process 800 may be performed in a different order than the order shown and/or one or more of the blocks of the example process 800 may not be performed. Further, any or all blocks of example process 800 may further be combined and done in parallel, in order, or out of order.

In FIG. 8, the exemplary method 800 of making a mixing container that facilitates a more convenient, affordable, and healthier consumable product for individuals who choose their raw ingredients and when to mix them to create the consumable product is shown. Method 800 begins at block 801. In block 803, the method includes forming a first opening in a first end of a container opposite to a second end of the container. In block 805, the method includes attaching the first end to a vessel. In block 807, the method includes forming a movable surface configured to be adjacent to the first end. In block 809, the method includes adjusting an openness of the first opening, using the movable surface, to control an amount of a material passing through the first opening.

In block 811, the method includes forming a second opening in the second end of the container. In some embodiments, a dispensing surface may be formed that extends at a nonzero angle between the first and second ends to aide in dispensing material in the container. The dispensing surface being configured to cover a portion of the first end and a portion of an interior surface of the container. In block 813, the method includes disposing the material in the container and disposing a liquid in the vessel, the liquid and the material being configured to be separate from each other until the first opening is adjusted. In some embodiments, the material is a soluble material. In some embodiments, the material being dispensed into the vessel may be processed or pre-processed to at least liquefy, chop, puree, mix, shredded, crush, ground, or blend the material. The method ending in block 815.

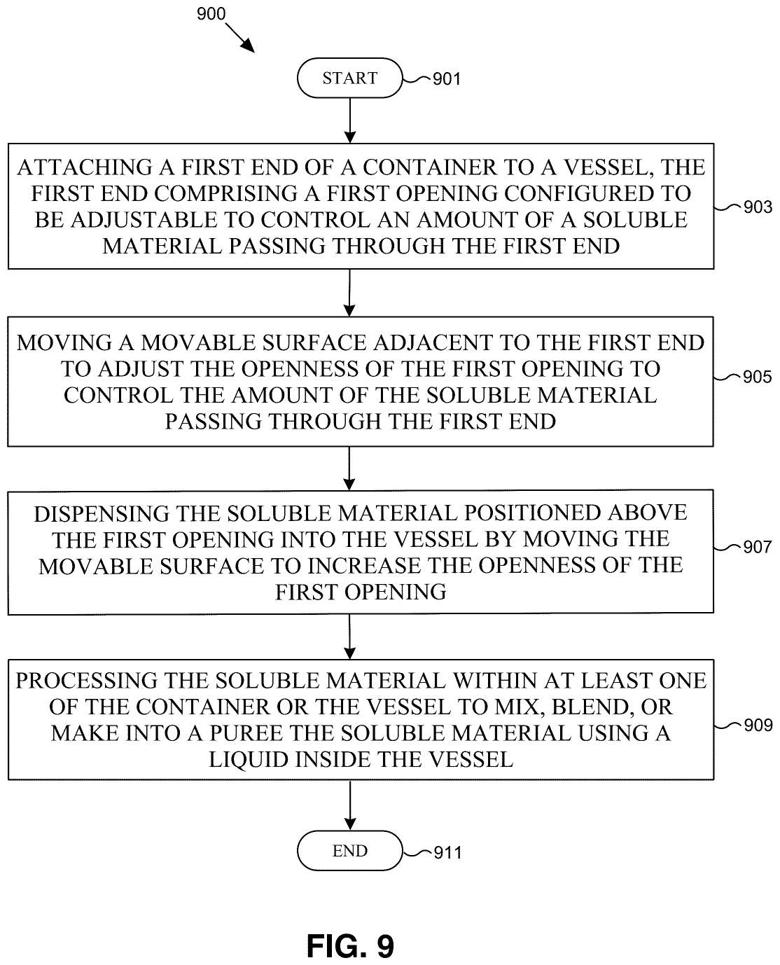

FIG. 9 illustrates an example flow chart showing a method of using an example container for dispensing a liquid mixture in accordance with one or more embodiments of the present disclosure. These exemplary methods are provided by way of example, as there are a variety of ways to carry out these methods. Each block shown in FIG. 9 represents one or more processes, methods or subroutines, carried out in the exemplary method. FIGS. 1-7F show example embodiments of carrying out the method of FIG. 9 for, for example, making a mixing container that facilitates a more convenient, affordable, and healthier consumable product for individuals who choose their raw ingredients and when to mix them to create the consumable product. Each block shown in FIG. 9 represents one or more processes, methods or subroutines, carried out in the exemplary method. The exemplary method may begin at block 901. Method 900 may be used independently or in combination with other methods or process for using an example container for dispensing a liquid mixture that facilitates a more convenient, affordable, and healthier consumable product for individuals who choose their raw ingredients and when to mix them to create the consumable product. For explanatory purposes, the example process 900 is described herein with reference to the digging tools and blades of FIGS. 1-7F. Further for explanatory purposes, the blocks of the example process 900 are described herein as occurring in serial, or linearly. However, multiple blocks of the example process 900 may occur in parallel. In addition, the blocks of the example process 900 may be performed in a different order than the order shown and/or one or more of the blocks of the example process 900 may not be performed. Further, any or all blocks of example process 900 may further be combined and done in parallel, in order, or out of order.

In FIG. 9, the exemplary method 900 of using a container for dispensing a liquid mixture that facilitates a more convenient, affordable, and healthier consumable product for individuals who choose their raw ingredients and when to mix them to create the consumable product is shown. Method 900 begins at block 901. In block 903, the method includes attaching a first end of a container to a vessel, the first end comprising a first opening configured to be adjustable to control an amount of a soluble material passing through the first end. In block 905, the method includes moving a movable surface adjacent to the first end to adjust the openness of the first opening to control the amount of the soluble material passing through the first end.

In block 907, the method includes dispensing the soluble material positioned above the first opening into the vessel by moving the movable surface to increase the openness of the first opening. In many embodiments, the vessel is configured to hold a liquid, and the liquid and the soluble material are configured to be separate from each other until the openness of the first opening is adjusted. In block 909, the method includes processing the soluble material within at least one of the container or the vessel to mix, blend, or make into a puree the soluble material using a liquid inside the vessel. In many embodiments, at least one of a mechanical device, an electrical device, a tool, or an appliance may be used to mix, blend, or make into a puree the soluble material using a liquid inside the vessel. In some embodiments, a second end of the container opposite to the first end comprises a second opening, and the second end is configured to be secured to at least one of a mechanical device, an electrical device, a tool, or an appliance. Further, the at least one of a mechanical device, the electrical device, the tool, or the appliance provides the soluble material for mixing with a liquid inside the vessel. The method ending in block 911.

The term “within a proximity”, “a vicinity”, “within a vicinity”, “within a predetermined distance”, “predetermined width”, “predetermined height”, “predetermined length” and the like may be defined between about 0.01 meter and about 0.3 meters. The term “coupled” is defined as connected, whether directly or indirectly through intervening components, and is not necessarily limited to physical connections. The connection may be such that the objects are permanently connected or releasably connected. The term “substantially” is defined to be essentially conforming to the particular dimension, shape, or other feature that the term modifies, such that the component need not be exact. For example, “substantially cylindrical” means that the object resembles a cylinder, but may have one or more deviations from a true cylinder. The term “comprising,” when utilized, means “including, but not necessarily limited to”; it specifically indicates open-ended inclusion or membership in the so-described combination, group, series and the like.

The term “a predefined” or “a predetermined” when referring to length, width, height, or distances may be defined as between about 0.01 meter and about 0.3 meters.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the present disclosure, the disclosure, the present disclosure, other variations thereof and alike are for convenience and do not imply that a disclosure relating to such phrase(s) is essential to the present disclosure or that such disclosure applies to all configurations of the present disclosure. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration.” Any embodiment described herein as “exemplary” or as an “example” is not necessarily to be construed as preferred or advantageous over other embodiments. Furthermore, to the extent that the term “include”, “have”, or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

The previous description of the disclosed embodiments is provided to enable a person skilled in the art to make or use the disclosed embodiments. Various modifications to these embodiments will be readily apparent to those skilled in the art, and the principles defined herein may be applied to other embodiments without departing from the scope of the disclosure. Thus, the present disclosure is not intended to be limited to the embodiments shown herein but is to be accorded the widest scope possible consistent with the principles and novel features as defined by the following claims.

The embodiments shown and described above are only examples. Many details are often found in the art such as the other features of an image device. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A container, comprising:
a first end and a second end opposite to the first end, the first end having an opening;
wherein the opening is configured to be adjustable to control an amount of material passing through therefrom; and
an attachment means for attaching the first end to a vessel.

2. The container of claim 1, wherein the attachment means is positioned on the first end, and wherein the attachment means secures the first end to the vessel.

3. The container of claim 1, wherein the container comprises a mechanical means for controlling the opening of the first end.

4. The container of claim 3, wherein the mechanical means is configured to gradually increase the openness of the opening, and wherein the mechanical means forms a cavity between the vessel and the container.

5. The container of claim 1, wherein the opening of the first end is a first opening, and wherein a second opening is formed on the second end.

6. The container of claim 5, further comprising a cap configured to detachably secure to the second end to cover the second opening.

7. The container of claim 5, further comprising a securing means positioned on the second end, wherein the securing means secures the second end to at least one of a mechanical device, an electrical device, a tool, or an appliance.

8. The container of claim 1, further comprising a dispensing surface extending at a nonzero angle between the first and second ends, wherein the dispensing surface is configured to cover a portion of the first end and a portion of an interior surface of the container.

9. The container of claim 1, wherein the material is a soluble material and the container is configured to hold the soluble material, wherein the vessel is configured to hold a liquid, and wherein the liquid and the soluble material are configured to be separate from each other until the opening is adjusted.

10. The container of claim 1, further comprising a mixing device configured to be attached to at least one of: the vessel or the container, the mixing device being configured to process the material being dispensed into the vessel.

11. A method of making a container for dispensing a liquid mixture, comprising:
forming a first opening in a first end of the container opposite to a second end of the container;
attaching the first end to a vessel; and
forming a movable surface, wherein the movable surface is configured to be adjacent to the first end, and wherein the movable surface adjusts the openness of the first opening to control an amount of material passing through therefrom.

12. The method of claim 11, further comprising forming a second opening in the second end of the container.

13. The method of claim 12, further comprising securing the second end to at least one of a mechanical device, an electrical device, a tool, or an appliance.

14. The method of claim 11, further comprising forming a dispensing surface extending at a nonzero angle between the first and second ends, wherein the dispensing surface is configured to cover a portion of the first end and a portion of an interior surface of the container.

15. The method of claim 11, further comprising disposing the material in the container and disposing a liquid in the vessel, wherein the material is a soluble material, and wherein the liquid and the soluble material are configured to be separate from each other until the first opening is adjusted.

16. The method of claim 11, further comprising processing the material being dispensed into the vessel to at least liquefy, chop, puree, mix, shredded, crush, ground, or blend the material.

17. A method of using a container for dispensing a liquid mixture, comprising:
attaching a first end of the container to a vessel, wherein the first end comprises a first opening configured to be adjustable to control an amount of a soluble material passing through therefrom;
moving a movable surface adjacent to the first end to adjust the openness of the first opening to control the amount of the soluble material passing through therefrom; and
wherein movement of the movable surface to increase the openness of the first opening dispenses the soluble material positioned above the first opening into the vessel.

18. The method of 17, wherein the vessel is configured to hold a liquid, and wherein the liquid and the soluble material are configured to be separate from each other until the openness of the first opening is adjusted.

19. The method of 17, further comprising securing a second end of the container to at least one of a mechanical device, an electrical device, a tool, or an appliance, the second end being opposite to the first end and comprising a second opening.

20. The method of 17, further comprising processing the soluble material within at least one of the container or the vessel, using at least one of a mechanical device, an electrical device, a tool, or an appliance to mix, blend, or make into a puree the soluble material using a liquid inside the vessel.
